(19) United States
(12) Patent Application Publication
(10) Pub. No.: US 2004/0129868 A1
(43) Pub. Date: Jul. 8, 2004

(54) Deflection sensor

(75) Inventor: Brian Kilmartin, Cheshire, CT (US)

Correspondence Address: Elsa Keller, Siemens Corporation, Intellectual Property Department, 170 Wood Avenue South, Iselin, NJ, 08830, US

(73) Assignee: Siemens VDO Automotive Corporation.

(21) Appl. No.: 10/658,516

(22) Filed: Sep. 9, 2003

Related U.S. Application Data
(60) Provisional application No. 60/438,757, filed on Jan. 8, 2003.

(51) Int. Cl. G01J 1/04; G01J 1/42

(52) U.S. Cl. 250/227.14

(57) ABSTRACT

The present invention relates to a torque sensor apparatus and method using variations in the microstructure of an optical waveguide affixed to the surface of a stress bearing member to measure the deflective force applied to the stress bearing member. A signal propagating through the optical waveguide is modified as a result of forces applied to the stress bearing member and to the optical waveguide. Induced changes in the index of refraction and alterations in the critical bending radius value of the optical waveguide result in modulation of the transmitted signal.

### FIELD OF INVENTION

The present invention relates to deflection sensing devices that measure applied deflection to a stress bearing element, and more particularly, to methods and apparatus for measuring deflecting force applied to a stress bearing element using an optical waveguide sense element.

### BACKGROUND

A common application for solid-state sensors is to translate mechanical properties, such as stresses and strains, into electrical signals. Typically, strain gauges examine bending and twisting of a substrate by quantifying electrical changes, such as current or voltage levels, associated with the deformation of a stimulated piezo-resistive sense-element. Measurements taken with such sensors can be used to monitor and record behavioral characteristics for study or to provide feedback in closed loop systems. As with many low-level electrical signals, stray electromagnetic fields (i.e., electromagnetic interference or electrical noise) can interfere and thus corrupt solid-state “hard-wired” sensors, rendering their measurements ambiguous. Most methods for making sensing systems more impervious to ambient noise are typically centered around shielding and grounding practices especially in the communication channel where the signal is transferred from the sense-element to the receiver. Noise entering at the sense-element itself rather than the communication channel can be the most difficult to distinguish and eliminate from the sought after information since early (post sense-element) amplification does not improve the signal-to-noise ratio.

Accordingly, it is an object of the present invention to overcome and mitigate at least one of the foregoing disadvantages.

### SUMMARY OF INVENTION

The deflection sensor described herein measures stress in a specimen imparted by a deflecting force by imposing corresponding changes into an optical fiber's index of refraction while exploiting the electromagnetic interference (EMI) immunity aspects that generally benefit the fiber optic field of discipline.

It is an object of the present invention to provide a photonic torque sensor that measures stress in a specimen imparted by a torque by imposing corresponding changes into an optical fiber's index of refraction while exploiting the electromagnetic interference (EMI) immunity aspects that generally benefit the fiber optic field of discipline.

It is an object of the present invention to provide an alternate approach to sensing stress and strain in a mechanical system based on the well-established EMI immunity of fiber optic communication channels.

It is an object of the present invention to provide an optical communication channel for visible and non visible frequencies that is immune to extraneous electromagnetic fields that would otherwise inject noise into the system.

Another object of the present invention is to provide an improved stress-measuring method be developed based on the deformation of an optical waveguide affixed to the stress-bearing specimen.

In accordance with the present invention, an apparatus for sensing deflection in a structural element, comprises a structural element, a waveguide affixed to the structural element in a fixed relative position, a transmitter and receiving apparatus in communication with the waveguide for sensing a transmitted signal therethrough, and a sensing apparatus for correlating sensed modulated signal with a deflection of the structural element.

In accordance with one aspect of this invention, a photonic torque sensor apparatus that senses torque applied to a stress bearing element in a vehicle, comprises a waveguide affixed to the stress bearing element wherein a deformation of the optical waveguide measures the torque applied to the stress bearing element.

In accordance with another aspect of this invention, a method for sensing deflection of a structural element comprises fixing a waveguide in relative position to a structural element, transmitting a signal through the waveguide and correlating differences in the signal to a deflection of the structural member.

In accordance with another aspect of this invention, a method for manufacturing a sense element immune to noise, the method comprises forming a waveguide and affixing the waveguide to the stress bearing element.

### BRIEF DESCRIPTION OF DRAWINGS

FIG. 1 is a perspective view of a fiber optic sense element affixed to a stress bearing element under a bending moment force.

FIG. 1a is a side view of a waveguide affixed to a stress bearing element under tensile or compressive forces.

FIG. 2 is an end view of fiber optic sense element bonded to a stress bearing element.

FIG. 3 is a perspective view of a fiber optic cable affixed to a torque bearing shaft.

FIG. 4. is a perspective view of a fiber optic sleeve affixed to a torque bearing shaft.

FIG. 5 is a graph showing wave fronts of light at the interface between two materials with different refractive indices.

FIG. 6 is a cross sectional view of a bent fiber optic cable.

FIG. 7 is a perspective view showing the clad material and core material of the fiber optic cable.

FIG. 8a is a side view of a waveguide affixed to a stress bearing element by mechanical fasteners.

FIG. 8b is a side view of a waveguide affixed to a stress bearing element by embedding techniques.

FIG. 8c is a side view of a waveguide affixed to a stress bearing element by standoffs.

FIG. 9 is a perspective view of multiple helical fiber optic cables affixed to a torque bearing shaft.

### DETAILED DESCRIPTION

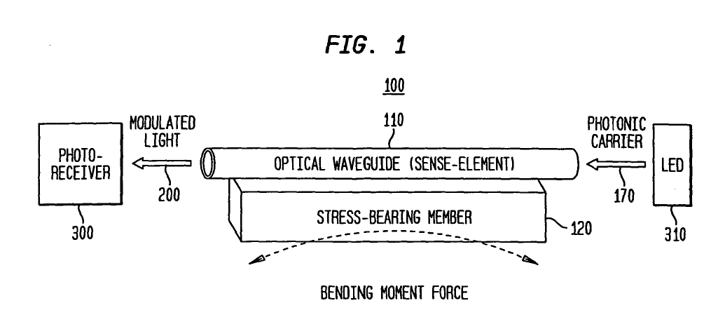

As shown in FIG. 1, the basic configuration of the stress measuring apparatus 100 and method comprises an optical waveguide 110 affixed on an edge to the stress bearing member 120. The optical waveguide 110 transmits ultraviolet, infrared, and far infrared frequencies. Others skilled in the art may use a waveguide that transmits both visible and non-visible frequency ranges or electromagnetic radiation waves.

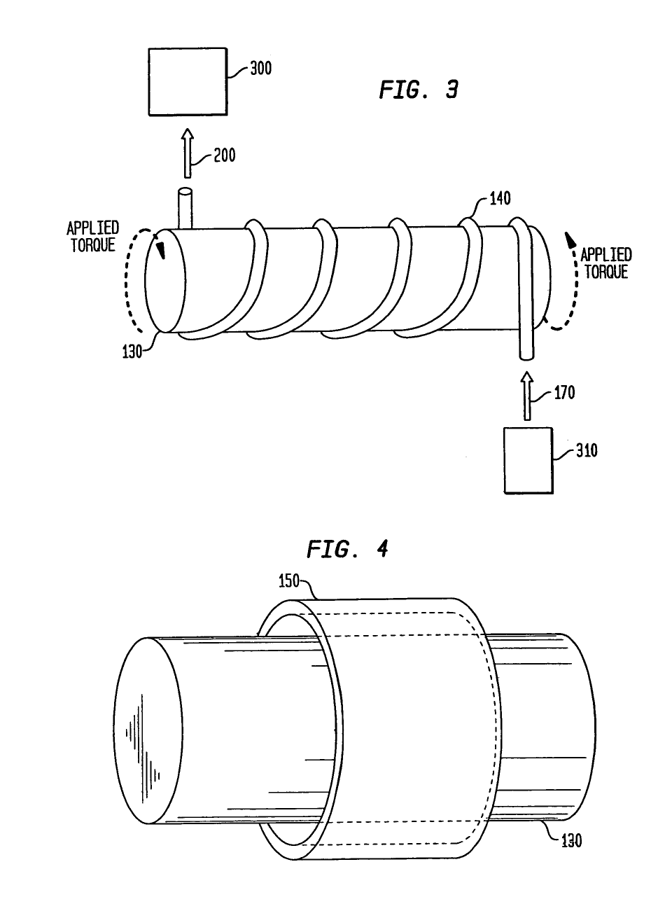

The stress bearing member 120 may be a beam as shown in FIG. 1 or a torque bearing shaft 130 as illustrated in FIG. 3 and will exhibit some degree of deformation stemming from an applied force. FIG. 1 shows the stress bearing element undergoing a bending moment deflecting force. FIG. 1a shows the stress bearing element undergoing a tensile or compressive deflective force. FIG. 3, the preferred embodiment, shows the torque bearing shaft 130 under going a torque driven deflecting force. The optical waveguide 110 may be a fiber optic cable 140 as illustrated in FIG. 3. FIG. 3 illustrates a preferred embodiment that uses a geometry that increases the amount of fiber optic cable 140 affixed to the surface of the torque bearing shaft 130 and aligns the fiber optic cable 140 with the principle stress vector of the torque bearing shaft 130. Using the torque bearing shaft 130 with the fiber optic cable 140 wound helically around its outside diameter, a force is applied in the form of a torque that acts to twist the torque bearing shaft 130. The torque bearing shaft 130, having torque applied to it, exhibits helical principle compressive and tensile stresses on its surface proportional to the magnitude of the torque.

The torque bearing shaft 130 requires composition of a compliant material (i.e. aluminum) for rigidity factors, as well as a diameter specification such that a smaller outside diameter facilitates more preload optical waveguide 110. Preload refers to an initial state where the optical waveguide 110 is already under a stress. The torque bearing shaft design exhibits a degree of twist over the torque range. The torque bearing shaft 130 comprises a cylindrical shape.

FIG. 4 shows an alternative embodiment where a stress measuring apparatus 100 uses a fiber optic sleeve 150 as an optical waveguide 110. Fiber optic sleeve 150 is coaxial in nature with a hollow interior permitting the torque bearing shaft 130 to be positioned at the concentric centerline. This approach promotes a freely rotating variation of the stress measuring apparatus 100 by facilitating the launching and collection of the optical signal through non-contacting means. Various physical embodiments are possible including direct deposition of the optical material to the underlying torque bearing shaft 130, or attachment mechanisms such as drawing-down a sleeve of optical material onto the torque bearing shaft 130, or affixing an optical sleeve 150 to the torque bearing shaft 130 through the use of adhesives.

The principle compressive and tensile stresses that develop along the two counter-spiraling, mutually orthogonal 45° helices are defined by the equation:

T=Tr/J

where T is the torque applied to the shaft 130, r is the shaft radius and J is the polar moment of inertia. Letting πr⁴/32=J for a solid cylindrical shaft and r=d/2 yields:

T=16T/πd³

Furthermore, the degree of twist experienced by the shaft 130 for a given torque is given by:

θ=32(LT)/(πd⁴G)

Where L is the length of the shaft 130, T is the applied torque, d is the diameter of the shaft 130 and G is the modulus of rigidity of the shaft 130. The modulus of rigidity defines the level of elasticity of the shaft material, thus, a lower G value would manifest in a shaft with a higher degree of twist for any given applied torque.

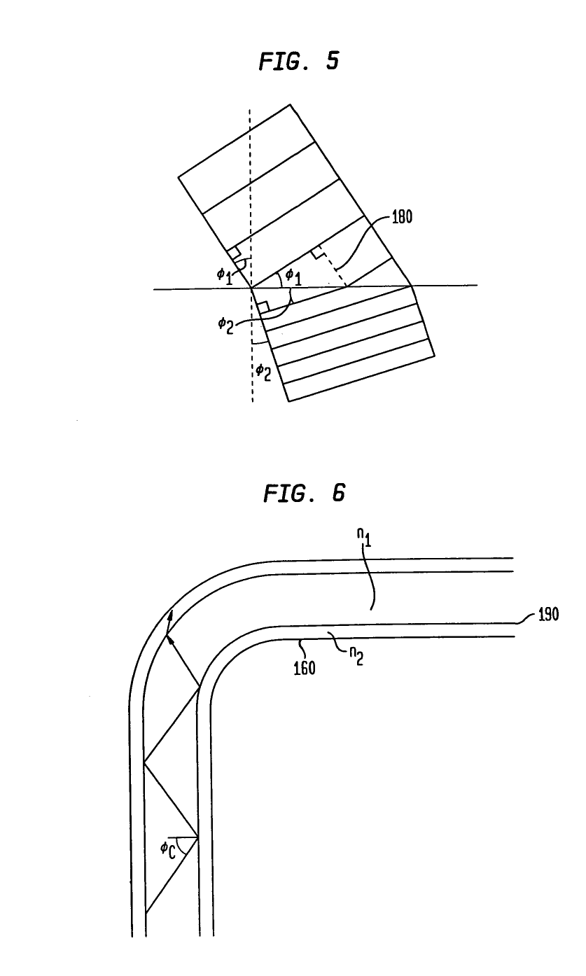

The fiber optic cable 140 may be actually fixed in relative position to the shaft 130 in order to predictably transfer stresses from the shaft 130 to the fiber optic cable clad 160 which refers to the outer surface (shown in FIG. 7) of the fiber optical cable 140. Similarly, the index of refraction of the cladding material 160 of the fiber optic cable 140 will change when the torque-imposed stresses alter its microstructure. The un-modulated (i.e., no torque signal present) transmission signal 170, preferably a photonic wave carrier, propagates along the fiber optic cable 140 according to Snell's Law. Others skilled in the art may choose to transmit electromagnetic radiation signals depending on the specific optical waveguide 110 used. Snell's Law describes the bending of light that occurs when light passes across the interface of two different materials. Referring to FIG. 5, the angle that light is refracted (i.e., bent away from a straight path) when passing across the interface between two such materials is related to the index of refraction of each material and the angle of the incidence light with respect to a line normal to the interface in accordance with the relationship:

n₁ sin Ø₁=n₂ sin Ø₂

The index of refraction, n, of a given material is defined as the ratio of the speed that light travels through that material, ν, and the speed that light travels through a vacuum, c.

n=c/ν

Thus, ν=c and n=1 for a vacuum. For any medium other than a vacuum, ν<c and n will be >1. Conversely stated, the velocity of light is greater for less dense materials manifesting in lower n values. As light slows down, it cover less distance in a given time period where n1<n2 and distance b<a. The distances a and b that light travels in a given time period, t, can be described in terms of light velocity as:

a=v₁t and b=v₂t

or, after rearranging variables,

v₁=a/t and v₂=b/t.

Since by definition n₁=c/v₁ and n₂=c/v₂, then after substitution, n₁ and n₂ can be rewritten as:

n₁=c/[a/t] and n₂=c/[b/t].

Solving for a and b in each equation, respectively, yields:

a=ct/n₁ and b=ct/n₂.

From the right triangle 180 of FIG. 5 with hypotenuse of length h and with one side of length a, it is evident from trigonometry that:

a=h sin Ø₁

or

h=a/(sin Ø₁).

In the other medium, the right triangle 180 with one side of length b shares the hypotenuse with the previously discussed right triangle and is described by:

b=h sin Ø₂

or

h=b/(sin Ø₂).

Combining the previous equations for h yields:

h=a/(sin Ø₁)=b/(sin Ø₂)

or

a sin Ø₂=b sin Ø₁.

Finally, substituting the solutions for a and b into the previous equation produces the form:

[ct/n₁]sin Ø₂=[ct/n₂]sin Ø₁.

Canceling terms that are common to both sides simplifies the equation to:

[1/n₁] sin Ø₂=[1/n₂] sin Ø₁

or

n₁ sin Ø₁=n₂ sin Ø₂

which is the common form of Snell's Law.

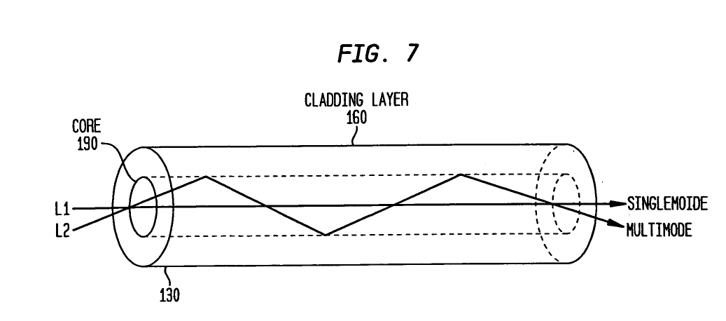

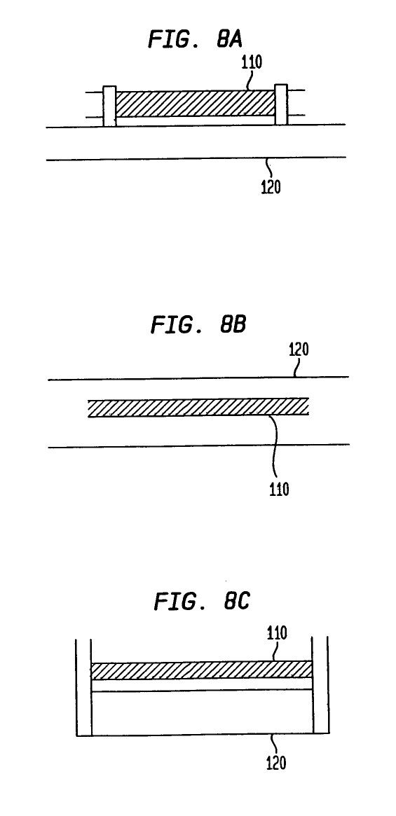

Referring to FIG. 6, in the case of the sensor apparatus 100, the speed of light is slower in the fiber optic cable's core 190, the inner surface of the fiber optic cable 140, than in the clad 160, the outer surface of the fiber optic cable 140, and the ratio between the two refractive indices are such that the light is totally internally refracted.

It should further be noted that the frequency of light in a vacuum, f_{c}, is related to its wavelength, λ, by the relationship:

f_{c}=c/λ.

The constant c is the speed of light in free space (i.e., a vacuum). In general, for propagating waves, the wavelength is:

λ=v/f_{c}

or

v=f_{c}λ.

This shows that the velocity of light, v, is directly proportional to its wavelength at a fixed frequency. In terms of the index of refraction, by considering a given frequency of light in free space and in some other medium, the equation for n becomes:

n=c/v=(f_{c}λ_{c})/(f_{c}λᵥ)=λ_{c}/λᵥ

or

n=λ_{c}/λᵥ.

A lightwave of frequency f_{c} that is propagating through free space at velocity c yielding a wavelength λ_{c} is compared to a lightwave, also of frequency f_{c}, propagating through some medium other than free space at velocity v yielding a wavelength λ_{c} to produce the ratio n. Once the lightwave leaves the vacuum and enters the denser medium, its velocity slows down as its wavelength grows thereby keeping its frequency unchanged at f_{c}. Finally, by combining n=c/v with n=λ_{c}/λᵥ the relationship:

c/v=λ_{c}/λᵥ

or

v=(λᵥ/λ_{c})c

is established.

As transmission signal 170 propagates through a medium, such as a fiber optic cable 140, its velocity is related directly to the wavelength of the transmission signal 170. More specifically, the longer wavelength of light, the faster it propagates. The equation for the propagation constant β also shows a decrease in propagation time with increasing wavelength:

β=2πn(λ)/λ

The index of refraction is more accurately specified as a function of the propagating light wavelength.

Therefore, the longer wavelength light will propagate faster than shorter wavelength light, thus, if a spectrum of light is launched into a medium, the longer wavelength will reach the receiver 300, preferably a photo receiver, first.

Referring to FIG. 7, the refractive index of a material is based on it microstructure and, as such, the index of refraction will be impacted by any microstructure changes stemming from externally imposed influences, such as torque-induced stress that affects the clad material 160 and/or the core 190 density. In the case of a fiber optic cable 140, altering the index of refraction of the clad material 160 in response to an external physical parameter creates modulation in the form of attenuation, lost modes, spectral spreading or chromatic dispersion (or combination of all conditions). Therefore, if the angle of refraction is changed significantly enough by the imparted torque-related stress variations in the index of refraction, then the modulated signal 200 or modulated light exiting the fiber cable 140 will show a measurable change, and the fiber optic cable 140 acts as a sense-element.

Cable bending affects the stress related changes in the microstructure of the fiber optic cable 140 and subsequent changes in its refractive index. Macro-bending imparts stresses into the microstructure that are analogous to those transmitted into it during torque sensing application. Furthermore, macro-bending is used to preload the cable 140 in its quiescent (no torque applied) state in order to make the influence of an imposed torque more immediate and substantial. Preloading systemically brings the cable 140 to a threshold point where additional stresses significantly impact optical carrier transmittal.

The minimum radius of curvature, minimum radius of bend or critical bending radius specifies the allowable amount of bending before the output signal is degraded such that the number of modes propagated drop by 50%. As explained earlier, the light of different frequencies travels at different velocities, refracts differently and thus, follows different paths as it propagates along the fiber optic cable 140. These paths are referred to as modes and are characterized by the frequency of light that they carry. Single mode optical cables are only capable of carrying one mode. Multi-mode cables carry more than one mode. All fiber optic cables 140 used for present invention are multi-mode type.

Referring to FIG. 6, the transmission signal 170 normally propagates light through a fiber optic cable 140 because the angle of refraction at the interface between the core 190 and clad material 160 is such that any light launched into one end of the fiber optic cable 140 at the correct angle is internally refracted back along the core 190. This is referred to as the critical angle and creates a condition identified as total internal refraction within the fiber optical cable 140. Radiation losses occur when light escapes from the total internal refraction state. Light that is incident upon the core material 190 and clad material 160 interface at an angle that is beyond the critical angle will be refracted out of the core 190 and into the clad 160 where it will be eventually dissipated.

The critical bending radius is given by:

R_{c}˜3n₁²λ/[4π(n₁²−n₂²)^{3/2}]

Note that the critical bending radius is a function of the index of refraction of both the clad material 160 and the core material 190. It is also affected by the wavelength of the propagating transmission signal 170, although, that parameter is held constant by design. By wrapping the fiber optic cable 140 around the torque bearing shaft 130, the cable 140 is brought close to the minimum curvature of radius, in effect, preloading the cable 140 such that additional torque induced stresses will rapidly attenuate the signal.

The fiber optic cable 140 may comprise plastic. However, one skilled in the art may use a different material such as glass. Similarly, the fiber optic cable 140 comprises multimode type. However, one skilled in the art may select a different type such as a single mode.

Having the fiber optical cable 140 mounted such that it is nearly at its minimum radius of curvature is crucial to obtaining the highest level of variation in the signal (or highest depth of modulation) in response to the applied force to the underlying the torque bearing shaft 130. Thus, quiescent state bending occurs by wrapping the fiber optic cable 140 around the shaft 130 placing the cable 140 in a condition where it is more susceptible to the influence of any additional stressing.

The fiber optic cable 140 affixes around the torque bearing shaft 130 along its helix. As mentioned earlier, the 45° helix of a solid cylindrical shaft is where primary torsional stresses (compressive and tensile) develop as torque is applied.

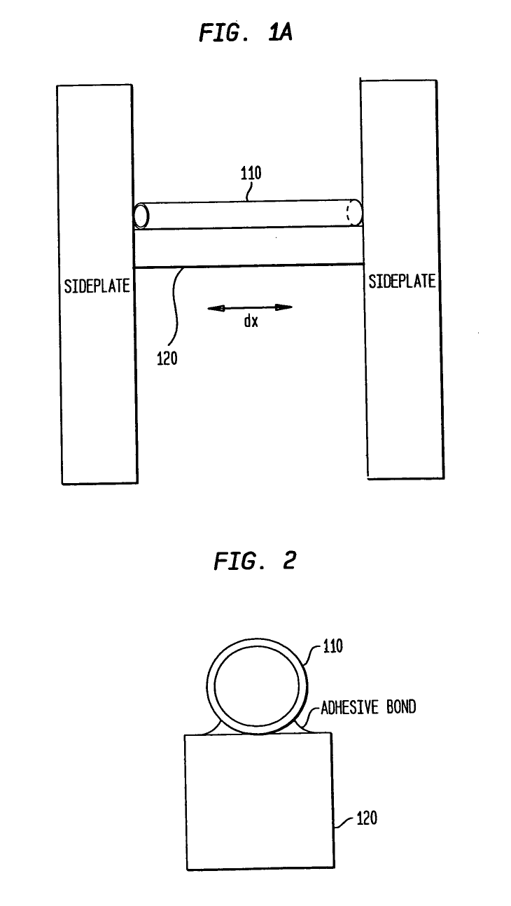

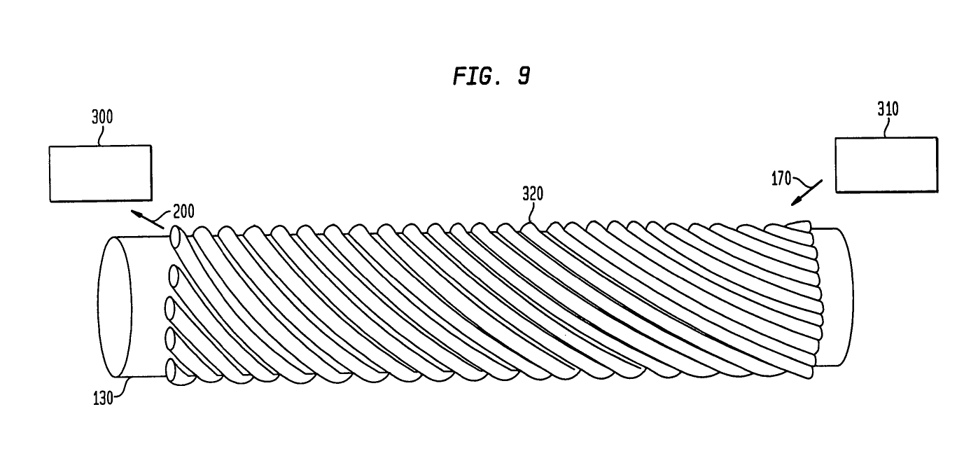

A suggested embodiment uses two-part epoxy that affixes the optical fiber 140 to the torque bearing shaft 130. The two-part epoxy does not attack the fiber optic cable 140 and can be a polymercaptan, amine, nonylphenol-based agent. Attachment of fiber optic cable 140 to the torque bearing shaft 130 is not limited to epoxy based schemes. Others skilled in material bonding techniques might utilize alternative adhesion methods including, a single stage glue or heating the shaft 130 so that the fiber optic cable 140 melts directly on the shaft 130. Affixing preserves the relative position between a stress bearing element 120 and an optical waveguide 110. One skilled in the art may affix the stress bearing member 120 to the optical waveguide 110 by bonding techniques, using mechanical fasteners, component embedding or molding, or using standoffs as shown in FIG. 2 and FIGS. 8a-8c. The preferred embodiment may use a bonding technique to affix the fiber optic cable 140 helically around the torque bearing shaft 130.

A receiver 300 with photodiode for collecting the modulated signal 200 and the LED optical transmitter 310 for emitting transmission signal 170 must also operate at the same wavelength as the individual fiber optic cables 140. The fiber optic cables 140 are generally optimized for the red visible light spectrum or light having a wavelength of 650 nm. The receiver 300 should preferably not have an integral signal conditioning (i.e., no output wave shaping). Signal conditioners, such as comparators, schmitt triggered gates, clippers and filters, would strip away the desired modulation. Thus, the receiver 300 preferably may be linear in nature. One skilled in the art may use a digital receiver with other corresponding processing means.

The fiber optical cable 140 is driven digitally by a standard LED optical transmitter 310. A current source and an analog oscillator drive the LED source 310. Others skilled in the art may use a laser light source in place of LED source 310.

Referring to FIG. 8, an alternative embodiment shows a multiple helical fiber optic cables 320 wrapped around the torque bearing shaft 130 at 45°. The multiple helical fiber optic cables 320 is contiguous, appearing like a ribbon cable, in effect creating a continuous sleeve that would permit a version of the stress measuring apparatus 100 with a freely rotating torque bearing shaft 130 and with a non-contacting excitation and output signaling. This embodiment allows RPM or rotational speed measurements and angular acceleration as the signal attenuates during the transition between the contiguous multiple fiber optic cables 320. As the torque bearing shaft 130 rotates, the amplitude of the output signal or modulated signal 200 will momentarily decrease after each of the multiple helical fiber optic cables 320 passes the stationary receiver 300.

Signal conditioning compares input and output signals. In a communications system, the output should be a reproduction of the input, thus, the input signal (photonic wave carrier 170) and the output signal (modulated signal 200) should be identical. Any differences can be found by subtracting the input signal from the output signal and would have to be attributed to distortion caused by the LED optical transmitter 310, the receiver 300, or the fiber optic cable 140. If the difference signal changes when stresses are imparted into the torque bearing shaft 130, then the source of the variation would be from changes in the fiber optic cable 140. Therefore, the fiber optic cable 140 would be sensing the stresses or torque applied to the torque bearing shaft 130. Alternative signal detection methods such as a phase-lock-loop approach or spectrum analysis may be used by those skilled in the art.

The present invention has been disclosed with reference to certain embodiments, numerous modifications, alterations, and changes to the described embodiments are possible without departing from the sphere and scope of the present invention. Accordingly, it is intended that the present invention not be limited to the described embodiments and equivalents thereof.

1. An apparatus for sensing deflection in a structural element, comprising:
a structural element;
a waveguide affixed to the structural element in a fixed relative position;
a transmitter and receiving apparatus in communication with the waveguide for sensing a transmitted signal therethrough; and
a sensing apparatus for correlating sensed modulated signal with a deflection of the structural element.

2. The apparatus of claim 1, wherein the structural element is a beam, a cylindrical shaft, and a torsion bar.

3. The apparatus of claim 1, wherein the transmitted signal comprises visible and non-visible frequency waves.

4. The apparatus of claim 1, wherein the transmitted signal comprises photonic waves and electromagnetic radiation waves.

5. The apparatus of claim 1, wherein the waveguide comprises fiber optic cable helically wrapped at 45° around the structural element.

6. The apparatus of claim 1, wherein the waveguide comprises multiple helical fiber optic cables helically wrapped at 45° around the structural element.

7. The apparatus of claim 1, wherein the waveguide comprises a fiber optic sleeve coaxially wrapped about the structural element.

8. The apparatus of claim 1, wherein the waveguide is driven by the transmitter comprising an electromagnetic radiation transmitter.

9. The apparatus of claim 1, wherein the transmitter comprises an LED source.

10. The transmitter of claim 9, wherein the LED source comprises a current source and an analog oscillator and emits the transmitted signal through a first end of the waveguide.

11. The apparatus of claim 1, wherein the waveguide is driven by a laser light source that emits the transmitted signal through the first end of the waveguide.

12. The apparatus of claim 1, wherein the receiver apparatus collects the modulated signal exiting through a second end of the waveguide.

13. The apparatus of claim 12, wherein the receiver apparatus conditions and analyzes the modulated signal with a signal processor.

14. The apparatus of claim 1, wherein a deformation of the waveguide comprises applying a stress to the structural element.

15. The apparatus of claim 14, wherein the stress comprises a torque.

16. The apparatus of claim 15, wherein the deformation of the waveguide results in altering an angle of refraction of the waveguide.

17. The apparatus of claim 1, wherein a modulation of the transmitted signal is measured by a chromatic dispersion, lost modes, and spectral spreading.

19. The apparatus of claim 1, wherein the modulation of the transmitted signal is measured by an attenuation of the transmitted signal as a function of a force applied to an outside surface of the waveguide.

20. The apparatus of claim 1, wherein the waveguide is affixed to the structural element in relative position by bonding techniques, using mechanical fasteners, component embedding or molding, and using standoffs.

21. The apparatus of claim 1, wherein the waveguide is melted onto the structural element by heating the stress bearing member.

22. A photonic torque sensor apparatus that senses torque applied to a stress bearing element in a vehicle, comprising:
a waveguide affixed to the stress bearing element wherein a deformation of the waveguide measures the torque applied to the stress bearing element.

23. The apparatus of claim 22, wherein the waveguide comprises an optical waveguide.

24. The apparatus of claim 22, wherein the stress bearing element is a beam, a cylindrical shaft, and a torsion bar.

25. The apparatus of claim 22, wherein the waveguide comprises fiber optic cable helically wrapped at 45° around the stress bearing element.

26. The apparatus of claim 22, wherein the waveguide comprises multiple helical fiber optic cables helically wrapped at 45° around the stress bearing element.

27. The apparatus of claim 22, wherein the waveguide comprises a fiber optic sleeve coaxially wrapped about the stress bearing element.

28. The apparatus of claim 22, wherein the waveguide is driven by an LED source comprising a current source and an analog oscillator.

29. The apparatus of claim 28, wherein the LED source emits a photon carrier wave through a first end of the optical waveguide.

30. The apparatus of claim 22, wherein the waveguide is driven by a laser light source that emits the photon carrier wave through the first end of the waveguide.

31. The apparatus of claim 22, wherein a receiver collects the modulated transmission signal exiting through the second end of the waveguide.

32. The apparatus of claim 22, wherein the receiver conditions and analyzes the modulated transmission signal with a signal processor.

33. The apparatus of claim 22, wherein the deformation of the waveguide comprises applying a stress to the stress bearing element.

34. The apparatus of claim 22, wherein the stress comprises a torque.

35. The apparatus of claim 22, wherein the deformation of the waveguide results in altering an angle of refraction of the waveguide.

36. The apparatus of claim 22, wherein the modulation of the transmission signal is measured by a chromatic dispersion, a lost modes, and a spectral spreading.

37. The apparatus of claim 22, wherein the modulation of the transmission signal is measured by an attenuation of the propagating transmission signal as a function of a force applied to an outside surface of the waveguide.

38. The apparatus of claim 22, wherein the waveguide is affixed to the structural element in relative position by bonding techniques, using mechanical fasteners, component embedding, component molding, and using standoffs.

39. The apparatus of claim 22, wherein the waveguide is melted onto the stress bearing element by heating the stress bearing member.

40. The apparatus of claim 22, wherein a vehicle is a wheeled, self-powered means for transportation.

41. Method for sensing deflection of a structural element comprising:
fixing a waveguide in relative position to a structural element;
transmitting a signal through the waveguide; and
correlating differences in the signal to a deflection of the structural member.

42. The method of claim 41, wherein the structural element is a beam, a cylindrical shaft, and a torsion bar.

43. The method of claim 41, wherein the signal comprises visible and non-visible frequency waves.

44. The method of claim 41, wherein the signal comprises photonic waves and electromagnetic radiation waves.

45. The method of claim 41, wherein the waveguide comprises fiber optic cable helically wrapped at 45° around the structural element.

46. The method of claim 41, wherein the waveguide comprises multiple helical fiber optic cables helically wrapped at 45° around the structural element.

47. The method of claim 41, wherein the waveguide comprises a fiber optic sleeve coaxially wrapped about the structural element.

48. The method of claim 41, wherein the waveguide is driven by the transmitter comprising an electromagnetic radiation transmitter.

49. The method of claim 41, wherein the transmitter comprises an LED source.

50. The transmitter of claim 49, wherein the LED source comprises a current source and an analog oscillator and emits the signal through a first end of the waveguide.

51. The method of claim 41, wherein the waveguide is driven by a laser light source that emits the signal through the first end of the waveguide.

52. The method of claim 41, wherein the receiver apparatus collects the modulated signal exiting through a second end of the waveguide.

53. The method of claim 41, wherein the receiver apparatus conditions and analyzes the modulated signal with a signal processor.

54. The method of claim 41, wherein a deformation of the waveguide comprises applying a stress to the structural element.

55. The method of claim 41, wherein the stress comprises a torque.

56. The method of claim 55, wherein the deformation of the waveguide results in altering an angle of refraction of the waveguide.

57. The method of claim 41, wherein a modulation of the signal is measured by a chromatic dispersion, lost modes, and spectral spreading.

58. The method of claim 41, wherein the modulation of the signal is measured by an attenuation of the transmitted signal as a function of a force applied to an outside surface of the waveguide.

59. The method of claim 41, wherein the waveguide is affixed to the structural element in relative position by bonding techniques, using mechanical fasteners, component embedding or molding, and using standoffs.

60. The method of claim 41, wherein the waveguide is melted onto the structural element by heating the stress bearing member.

61. Method for manufacturing a sense element immune to noise in a vehicle, the method comprising:
forming a waveguide; and
coupling a waveguide to stress bearing element.

62. The method of claim 61, wherein the stress bearing element is a beam, a cylindrical shaft, and a torsion bar.

63. The method of claim 61, wherein the waveguide comprises fiber optic cable helically wrapped at 45° around the stress bearing element.

64. The method of claim 61, wherein the waveguide comprises multiple helical fiber optic cables helically wrapped at 45° wrapped around the stress bearing element.

65. The method of claim 61, wherein the optical waveguide comprises a fiber optic sleeve coaxially wrapped around the stress bearing element.

66. The method of claim 61, wherein the waveguide is affixed to the structural element in relative position by bonding techniques, using mechanical fasteners, component embedding, component molding, and using standoffs.

67. The method of claim 61, wherein the waveguide is melted onto the stress bearing element by heating the stress bearing member.

68. The method of claim 61, wherein a vehicle is a wheeled, self-powered means for transportation.
